(19) United States
(12) Patent Application Publication
(10) Pub. No.: US 2019/0073576 A1
(43) Pub. Date: Mar. 7, 2019

(54) DEVICE AND SYSTEM FOR CHECKING THE PRESENCE OF ARTICLES ON SHELVES AND CORRESPONDING METHOD

(71) Applicant: TAGSYS, La Ciotat (FR)

(72) Inventor: Franck D'ANNUNZIO, La Ciotat (FR)

(21) Appl. No.: 15/779,393

(22) PCT Filed: Nov. 25, 2016
(86) PCT No.: PCT/FR2016/053102

§ 371 Date: Oct. 24, 2018

(30) Foreign Application Priority Data
Nov. 26, 2015 (FR) 1561431

(51) Int. Cl. G06K 19/07; G06K 17/00

(52) U.S. Cl. CPC G06K 19/0717; G06K 2017/0051; G06K 17/0022

(57) ABSTRACT

Some embodiments relate to a device for checking the presence of articles on a shelf, that includes a detector circuit for detecting the presence of at least one article placed in at least one area of the shelf, the detector circuit being capable of switching between an article detection state, wherein it detects the presence of at least one article in the area, and an article non-detection state, wherein it does not detect any article in the area, and an RFID tag connected to the detector circuit and capable of reading and storing the article detection state or article non-detection state, of the detector circuit, the RFID tag further including an identification code for identifying the shelf area and being arranged to communicate the identification code and the state of the detector circuit to a remote RFID reader.

### CROSS REFERENCE TO RELATED APPLICATIONS

This application is a national phase filing under 35 C.F.R. § 371 of and claims priority to PCT Patent Application No. PCT/FR2016/053102, filed on Nov. 25, 2016, which claims the priority benefit under 35 U.S.C. § 119 of French Patent Application No. 1561431, filed on Nov. 26, 2015, the contents of each of which are hereby incorporated in their entireties by reference.

### BACKGROUND

Some embodiments relate to checking stocks of merchandise, and more particularly automatically checking for the presence of articles or of merchandise on shelves in a warehouse, a premises or a shop.

The related art includes systems that make it possible to carry out an inventory of the articles present on shelves of storage racks. Each article is provided with a barcode or an RFID tag (for Radio Frequency IDentification) and an associated reader is used to read the barcode or the RFID tag of each one of the articles present on the shelves. This system is not automatic and may require an operator to pass through all of the storage racks for the barcodes or the RFID tags of all the articles present on the shelves.

Other systems based on radio transmission exist. These systems are generally complex to implement and have a high cost. Such a system is, for example, described in International Application WO 2007/002536. This system includes a plurality of sensors arranged on shelves intended to receive articles or merchandise. The sensors are connected to electronic modules that can communicate by radio with a computer or remote server. The electronic modules of the same set of superimposed shelves can optionally be connected by radio to the same network node and communicate with the remote computer via this network node. Moreover, the sensors can be of different types: capacitive sensors, wave guide sensors or photosensitive sensors.

### SUMMARY

This system makes it possible to automatically detect the presence or not of articles in the zones of the shelves equipped with sensors. It however may require a rather heavy infrastructure: sensors that have their own electrical power supply or powered by the electronic modules, electronic modules that have their own electrical power supply, optionally network nodes, and a remote computer provided with emission/reception devices. Many cables may also be required to connect the sensors to the electronic modules.

Some embodiments address or overcome all or a portion of the aforementioned disadvantages.

Some embodiments are directed to an automatic system for checking the presence or not of articles on shelves that is based on RFID technology. The system uses RFID tags and connects them to detector circuits that can detect the presence or not of articles on the shelves, the RFID tags being able to read and store the state of the detector circuits. These states are transmitted to a remote RFID reader when the latter reads the RFID tags.

To this effect, some embodiments relate to a device for checking the presence of articles on at least one shelf, including:
at least one detector circuit for detecting the presence of at least one article placed in at least one area of the shelf, called shelf area, the detector circuit being capable of switching between at least one state, called article detection state, wherein the detector circuit detects the presence of at least one article in the shelf area and a state, called article non-detection state, wherein the detector circuit does not detect any article in the shelf area, and
an RFID tag connected to the detector circuit and capable of reading and storing the article detection state or article non-detection state, of the detector circuit, the RFID tag further including an identification code for identifying the shelf area and being arranged to communicate the identification code and the state of the detector circuit to a remote RFID reader.

The device proposed is simple and inexpensive to implement since it is based on the existing RFID technology. The term RFID tag means a device including an RFID chip connected to an antenna. The antenna makes it possible to both capture the electromagnetic signal emitted by the RFID reader and to transmit the information contained in the chip to the RFID reader, in particular the state of the detector circuit.

Advantageously, the detector circuit is supplied with power by the RFID tag to which it is detected.

According to a particular embodiment, the RFID tag is passive.

According to a particular embodiment, the detector circuit is a pressure sensor arranged on an upper face of the shelf, the detector circuit being in the article detection state when an article arranged on the shelf exerts a pressure on the sensor and in the article non-detection state when no article is exerting pressure on the sensor.

According to a particular embodiment, the pressure sensor is a switch including two conductive elements, the conductive elements being in contact when an external pressure is exerted on the sensor.

According to another particular embodiment, the RFID device includes:
a first layer including a conductive plate,
a second layer including two conductive elements forming contacts of the switch and the RFID tag, with a portion of each one of the two conductive elements in facing relation with the conductive plate, with the two conductive elements being electrically connected to the RFID tag, and
a third layer between the first and second layers, the third layer being an elastic dielectric layer including a window on the conductive plate, the conductive elements being electrically connected via the conductive plate when an external pressure is exerted on the switch.

According to another particular embodiment, the third dielectric layer is an adhesive layer intended to assemble the first layer to the second layer.

According to another particular embodiment, the detector circuit is a photoresistor of which the resistance varies according to the quantity of light received, with the photoresistor being arranged on the shelf or in the vicinity of the latter and the quantity of light received by the photoresistor varying according to the presence of at least one article on the shelf.

According to another particular embodiment, the detector circuit is a resistive pressure sensor of which the resistance varies according to the pressure applied.

According to another particular embodiment, the RFID tag is connected to a plurality of detector circuits mounted in series.

Some embodiments also relate to a system for checking the presence of articles on at least one shelf, including at least one device for checking the presence of articles such as described hereinabove and a remote RFID reader able to communicate with the RFID tag and to receive the state of the detector circuit stored in the RFID tag.

Other advantages can further appear to those of ordinary skill in the art when reading the examples hereinbelow, shown in the accompany figures, provided for the purpose of illustration.

### BRIEF DESCRIPTION OF THE FIGURES

FIG. 1 shows a diagram of an RFID device in accordance with some embodiments;

FIG. 2 shows an exploded diagrammatical view in perspective of a first embodiment of the RFID device of FIG. 1;

FIG. 3 shows a diagrammatical view of a system for checking the presence of articles on shelves in accordance with some embodiments;

FIG. 4 is an enlarged view of a shelf visible in FIG. 3, the shelf is provided with RFID devices in accordance with some embodiments; and

FIG. 5 is a diagrammatical view of a second embodiment of the RFID device in accordance with some embodiments.

### DETAILED DESCRIPTION OF EXEMPLARY EMBODIMENTS

Some embodiments relate to an RFID device and an RFID system for checking the presence of articles on shelves. Some embodiments can be used for shop owners or industrials that have articles on shelves and who would like to know if some of these shelves are empty or partially empty in order to restock them.

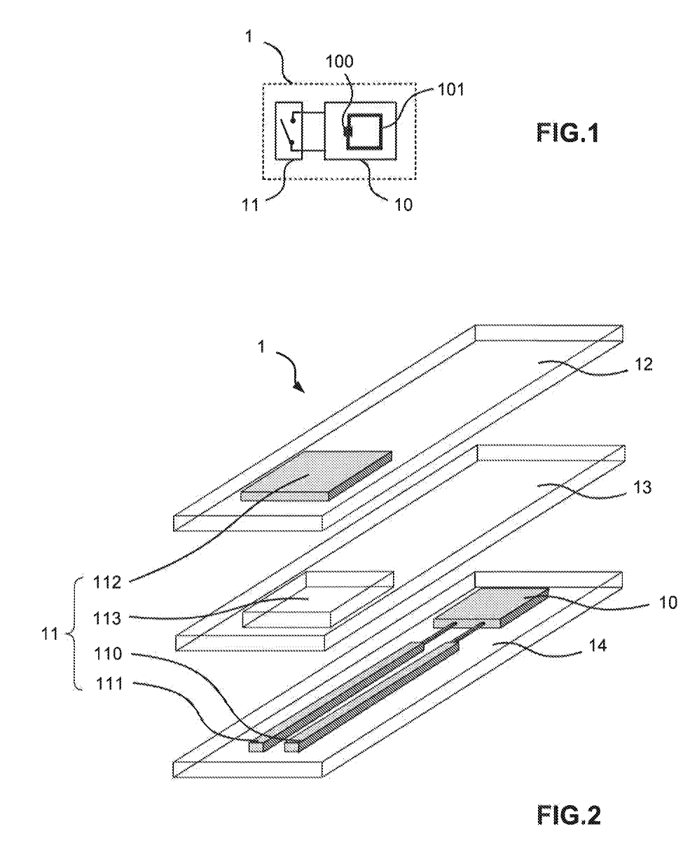

To this effect, the shelves are each equipped with one or several RFID devices in accordance with some embodiments. In reference to FIG. 1, each RFID device, referenced as 1, includes a detector circuit 11 for detecting the presence of at least one article on a zone of the shelf and an RFID tag 10 electrically connected to the detector circuit.

The RFID tag 10 includes two ports between which the detector circuit 11 can be connected and from which it can read the state of the detector circuit.

The RFID tag 10 is advantageously a passive tag that does not have a battery. The tag then draws its power in the electromagnetic signal emitted by an RFID reader during the reading of the tag. This power is used by the RFID tag to read the state of the detector circuit and to return an electromagnetic signal to the RFID reader, with the returned signal including a plurality of information coming from the RFID chip of the tag, in particular an identification code of the shelf or of the shelf zone whereon is placed the detector circuit connected to the tag as well as the state of the detector circuit.

The RFID tag 10 substantially includes an RFID chip 100 connected to a magnetic loop 101. The magnetic loop is advantageously coupled to an electric antenna, for example an electric dipole of length k/2, arranged on the shelf. k designates the wavelength associated with the operating frequency of the RFID reader.

The RFID tag 10 is, for example, equipped with the chip G2iL+ marketed by the company NXP. This chip has two auxiliary ports, referenced as VDD and OUT, between which it injects a low current and measures the resulting voltage. This function (current injection and voltage measurement) is carried out automatically at each start cycle of the chip during a predetermined interval of time of a few hundred microseconds. This function is used by the RFID tag 10 to determine the state of the detector circuit 11.

The detector circuit 11 is arranged to switch between a state, called article detection state, in which it detects the presence of at least one article on the shelf and a state, called article non-detection state, in which it does not detect any article on the shelf.

The detector circuit 11 is, for example, a pressure sensor arranged on the upper face of the shelf. This sensor changes state when an article present on the shelf exerts a pressure on it.

The detector circuit is advantageously a simple switch that changes state according to the presence or the absence of an article exerting a pressure on it as shown in FIG. 1. This switch includes two conductive elements which are in contact when the weight of an article present on the shelf exerts a pressure on the switch.

An exploded view of a first embodiment of the RFID device 1 is provided in FIG. 2. In this example, the RFID device 1 includes three superimposed dielectric layers, referenced as 12, 13 and 14.

The layer 12 includes a conductive plate 112. The layer 14 includes two conductive elements 110 and 111 forming the switch contacts as well as the RFID tag 10. The layer 13 is an elastic layer arranged between the layers 12 and 14 and includes a window 113. The conductive elements 110 and 111 and the conductive plate 112 are arranged in such a way that an end portion of each one of the conductive elements is in facing relation with the conductive plate 112. Likewise, the window 113 is positioned in such a way as to be in facing relation with the conductive plate 112.

When an external pressure is exerted on the switch, the conductive plate 112 is pushed towards the conductive elements 110 and 111 through the window 113 in such a way that the two conductive elements 110 and 111 are electrically connected via the conductive plate 112. The article detection state is obtained when the two conductive elements 110 and 111 are electrically connected (switch closed). When the pressure is released (removal of the article exerting the pressure), the two conductive elements 110 and 111 separate from the conductive plate in such a way as to cut off the electrical connection between the two conductive elements (switch open). The article non-detection state is as such obtained when this electrical connection does not exist.

In this embodiment, the layer 13 is advantageously an adhesive layer intended to assemble the two layers 12 and 14.

According to a particular embodiment, the layer 12 is a layer made of PET with a thickness of 40 μm and including a plate 112 of laminated metal with a thickness between 20 μm and 30 μm. The plate 112 is made of copper or aluminium. The layer 14 is also a layer made of PET with a thickness of 40 μm and including two conductive elements made of laminated metal with a thickness between 20 μm and 30 μm. Finally the intermediate layer, 13, is a layer of elastic adhesive material reinforced with PET in such a way that the adhesive material does not bleed. This adhesive layer has a thickness between 20 μm and 30 μm and attaches all the layers of the tag.

Advantageously, the upper face of the layer 12 is covered by an opaque polyester film and the lower face of the layer 14 is covered with an adhesive layer for gluing the detector circuit on the shelf.

According to some embodiments, the RFID tag 10 is arranged to read and store the state of the detector circuit 11. In the case of the chip G2iL+ mentioned hereinabove, the detector circuit 11 is connected between the auxiliary ports VDD and OUT of the chip. At the waking of the latter (following the emission of an electromagnetic signal by an RFID reader), the chip injects into the detector circuit 11 a low current (less than 1 hA) during a very short internal of time, of about 300 μs. If the detector circuit 11 is in an article detection state (switch closed—existence of a pressure exerted by an article), the chip measures a quasi-zero voltage between the auxiliary ports VDD and OUT. The chip analyses this measurement as meaning that the switch is closed (i.e. the detector circuit 11 is in an article detection state). The chip then records, in one of its memory registers, a binary information (for example, a “1”) that represents this state of the detector circuit 11. On the contrary, if the detector circuit 11 is in an article non-detection state (switch open—absence of pressure exerted by an article), the chip measures a high voltage (high impedance) between the auxiliary ports VDD and OUT. The chip analyses this measurement as meaning that the switch is open (i.e. the detector circuit 11 is in an article non-detection state). The chip then records a binary information (for example a “0”) that represents this state of the detector circuit 11.

The chip also permanently stores, in one of its registers, a predetermined identification code that makes it possible to identify the shelf or the shelf zone whereon is arranged the detector circuit 11. This identification code can be a shelf or shelf zone number or an identification number of the articles intended to be stored on this shelf. This identification code is used by the RFID reader to identify the shelves or shelf zones to be restocked.

After storage of the binary information that represents that state of the detector circuit 11 (end of the wake cycle of the chip), the RFID tag 10 returns to the RFID reader the binary information that represents this state of the detector circuit 11 and the identification code stored in the chip.

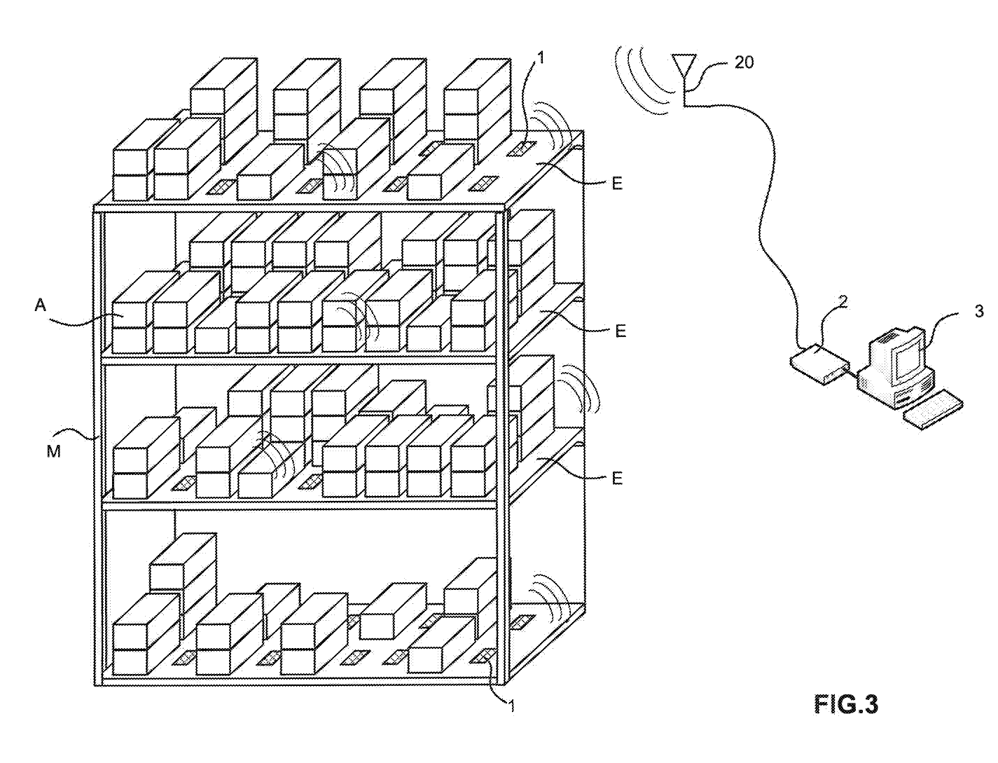

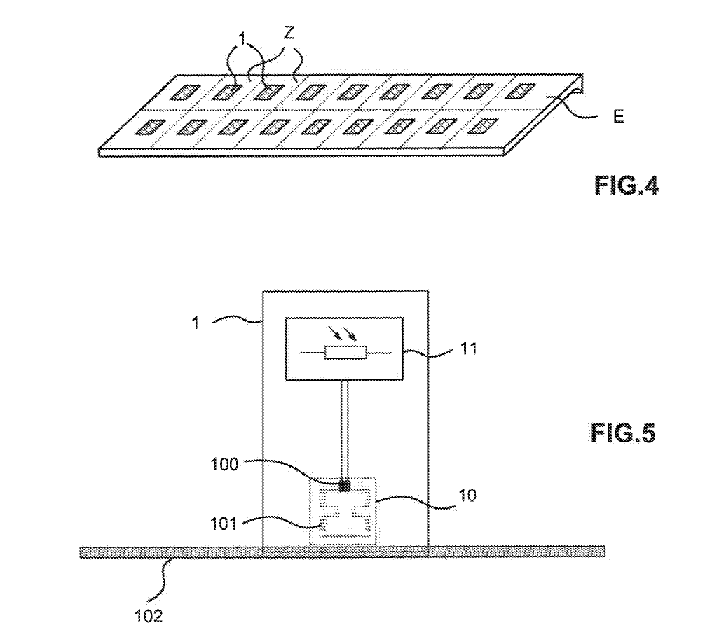

The RFID device 1 such as described hereinabove is positioned on the shelves E for storing articles A as shown in FIGS. 3 and 4. In these two figures, the shelves are intended to receive boxes of shoes A.

FIG. 3 shows a system in accordance with some embodiments including a plurality of RFID devices 1 such as described hereinabove and able to communicate with a remote RFID reader 2 connected to a central server 3. The RFID devices 1 are represented by rectangles with hatched lines in FIGS. 3 and 4. They are arranged on shelves E.

The RFID reader is equipped with at least one UHF antenna 20 arranged in the vicinity of the shelves. This antenna is for example of the circular polarisation patch type and arranged in the vicinity of the shelves. In a shop or premises, the antennas can be placed in suspended ceilings or behind the shelves. In this latter case, the UHF antennas are advantageously or preferably dipole antennas because they make it possible to communicate with two shelves placed back-to-back.

The UHF antennas 20 are connected to the RFID reader 2 via a coaxial cable. Current RFID readers make it possible to connect from 4 to 16 antennas, where applicable by adding multiplexers. As such a single RFID reader can easily cover a span from 4 to 10 meters according to the arrangement and the density of the shelves E to be monitored.

The RFID readers are connected to a central server of the shop via an Ethernet wired computer network or Wi-Fi if the wired network is not preinstalled.

FIG. 4 shows an enlarged view of a shelf E of the system of FIG. 3, whereon are glued a plurality of RFID devices 1 in accordance with some embodiments. In this figure, the upper face of the shelf is cut into 18 adjacent zones Z, with each zone Z equipped with an RFID device 1. The zones Z are materialized in the figure with dotted lines. The extent of each zone Z is defined according to the size of the article that it is to receive. If the shelf is intended to receive boxes of shoes as is the case here, the zones Z correspond substantially to the surface of the lower face of the boxes of shoes.

Of course, the zones Z can be of different sizes if the shelf is intended to receive articles of different sizes.

In the example of FIG. 4, the RFID device 1 is positioned at the centre of the zone Z. It can of course be positioned in any other location of the zone Z. It may be required that the detector circuit 11 of the RFID device 1 be positioned under the box of shoes when the latter is in place on the shelf.

Note that in the case of articles A including metal parts, it is recommended to offset the RFID tag 10 with respect to the detector circuit 11 so that the RFID tag is not located under the article placed on the shelf. The RFID tag 10 can then be positioned on one of the vertical edges of the shelf or on one of the risers M that support the shelf.

The system of FIG. 3 operates in the following way. The RFID reader 2 supplies in turn the antennas 20 according to the UHF RFID Gen2 protocol. The chips of the RFID tags 10 that receive enough incident electromagnetic field awake. When powered up, each chip checks the state of the detector circuit connected between its auxiliary ports. It measures the state of the detector circuit 11 during the first hundred microseconds and stores in one of its registers a binary information that represents this state.

This operation is carried out transparently during the period (the first 500 microseconds) where no command can be sent by the RFID reader such as defined in the UHF Gen2 communication protocol.

After this period, the chip is ready to communicate with the RFID reader 2 and responds to inventory commands by returning its identification code and the binary information that represents the state of the detector circuit. Its information is contained in the EPC (Electronic Product Code) returned by the chip to the RFID reader during the time interval that is attributed to it by the protocol. This EPC code can contain information over 96 bits making it possible to know the spatial position of the shelf and/or the code of the article on the shelf.

The central server 3 thus receives, via the RFID reader 2, the state of the detector circuits of the various RFID devices 1 arranged on the shelves E. The server can then decide to issue a restocking alert as soon as a detector circuit is no longer covered by an article A. It can also decide to issue a restocking alert only when m RFID devices out of a total of n RFID devices arranged on a shelf are no longer covered by an article, with 1<m<n.

The embodiments described hereinabove were provided as examples. It is obvious for those of ordinary skill in the art that they can be modified, in particular as to the type of detector circuit 11 used, the number of detector circuits connected to the RFID tag, the number of RFID devices placed on a shelf, etc.

Other types or structures of detector circuits can be used. According to another embodiment, the detector circuit 11 is a photoresistor of which the resistance varies according to the quantity of light received. This photoresistor is arranged on the shelf or in the vicinity of the latter. The presence or not of one or several articles on the shelf will modify the quantity of light received by the photoresistor. As for the detector circuit 11 described hereinabove, the photoresistor is connected between two auxiliary ports of the RFID tag 10. The passage of a low current in the photoresistor is used to measure the resistance of the photoresistor and to deduce therefrom the absence or the presence of an article on the detector circuit or in the vicinity of the latter.

This alternative is shown in FIG. 5. The RFID tag includes an RFID chip 100 connected to a magnetic loop 101 resonating at UHF frequencies between 860 MHz and 960 MHz according to the geographical zone. The RFID chip 100 is connected on a flexible support to a photoresistor forming a detector circuit 11. The magnetic loop 101 is coupled to an electric radiating element 102 of a length of λ/2. λ designates the wavelength associated with the UHF frequency of the loop. The radiating element, forming an electric antenna, is arranged on the shelf. The shelves are advantageous or preferably made of a dielectric material, for example wood, in order to avoid disturbing the operation of the antennas.

In the case of metal shelves, foam separators a few millimetres thick are placed between the upper or lower face of the shelf and the radiating element in order to re-establish standard communication distances for RFID.

Another possibility is to replace the radiating element with a slot of the same length according to the Babinet principle, with this slot being cut in the shelf.

According to another particular embodiment, the detector circuit 11 is a resistive pressure sensor of which the resistance varies according to the pressure applied.

According to another embodiment, the detector circuit 11 includes two conductive elements facing separated by a dielectric layer, for example PET. The detector circuit is then equivalent to a plate capacitor, with the two conductive elements forming the two armatures of the capacitor. The pressure exerted by an article on the detector circuit will increase the capacitance of the capacitor. This increase in capacitance can be detected by the chip G2iL+. Indeed, the increase in the capacitance of the detector circuit will extend the response time of the latter to the current pulse. The response time of the detector circuit becomes greater than the measurement period (200 μs) of the chip.

According to another embodiment, the RFID tag 10 is optionally connected to a plurality of detector circuits 11 mounted in series. The RFID device detects the presence of at least one article on the shelf if all of the detector circuits 11 are in an article detection state.

Some embodiments have many advantages. It can be simple to implement (RFID technology) and inexpensive. The RFID device can be carried out by conductive and semi-conductive material printing techniques with a low cost.

Using RFID integrated circuits makes it possible to facilitate the installation of these detection surfaces without any power wire or network connection. The RFID allows for remote power at a distance through a network of RFID UHF antennas as well as the transmission of data in half-duplex.

1. A device for checking the presence of articles on a shelf, comprising:
at least one detector circuit for detecting the presence of at least one article placed in at least one area of shelf, the detector circuit being capable of switching between at least one detection state, in which the detector circuit detects the presence of at least one article in the area, and a non-detection state in which the detector circuit does not detect any article in the area, and
an RFID tag connected to the detector circuit and capable of reading and storing the article detection state or article non-detection state, of the detector circuit, the RFID tag further including an identification code for identifying the shelf area and being arranged to communicate the identification code and the state of the detector circuit to a remote RFID reader.

2. The device according to claim 1, wherein the detector circuit is supplied with power by the RFID tag to which it is detected.

3. The device according to claim 1, wherein the RFID tag is passive.

4. The device as claimed in claim 1, wherein the detector circuit is a pressure sensor arranged on an upper face of the shelf, the detector circuit being in the article detection state when an article arranged on the shelf exerts a pressure on the sensor and in the article non-detection state when no article is exerting pressure on the sensor.

5. The device according to claim 4, wherein the pressure sensor is a switch including:
a first layer including a conductive plate,
a second layer including two conductive elements forming contacts of the switch and the RFID tag, with a portion of each one of the two conductive elements in facing relation with the conductive plate, with the two conductive elements being electrically connected to the RFID tag, and
a third layer between the first and second layers, the third layer being an elastic dielectric layer including a window on the conductive plate, the conductive elements being electrically connected via the conductive plate when an external pressure is exerted on the switch.

6. The device according to claim 1, wherein the third layer is an adhesive layer intended to assemble the first layer to the second layer.

7. The device according to claim 1, wherein the detector circuit is a photoresistor of which the resistance varies according to the quantity of light received, with the photoresistor being arranged on the shelf or in the vicinity of the latter and the quantity of light received by the photoresistor varying according to the presence of at least one article on the shelf.

8. The device as claimed in claim 1, wherein the RFID tag is connected to a plurality of detector circuits mounted in series.

9. A system for checking the presence of articles on at least one shelf, comprising:
the device for checking the presence of articles according to claim 1; and
a remote RFID reader able to communicate with the RFID tag and to receive the state of the detector circuit stored in the RFID tag.

10. The device according to claim 2, wherein the RFID tag is passive.

11. The device as claimed in claim 2, wherein the detector circuit is a pressure sensor arranged on an upper face of the shelf, the detector circuit being in the article detection state when an article arranged on the shelf exerts a pressure on the sensor and in the article non-detection state when no article is exerting pressure on the sensor.

12. The device as claimed in claim 3, wherein the detector circuit is a pressure sensor arranged on an upper face of the shelf, the detector circuit being in the article detection state when an article arranged on the shelf exerts a pressure on the sensor and in the article non-detection state when no article is exerting pressure on the sensor.

13. The device according to claim 2, wherein the detector circuit is a photoresistor of which the resistance varies according to the quantity of light received, with the photoresistor being arranged on the shelf or in the vicinity of the latter and the quantity of light received by the photoresistor varying according to the presence of at least one article on the shelf.

14. The device according to claim 3, wherein the detector circuit is a photoresistor of which the resistance varies according to the quantity of light received, with the photoresistor being arranged on the shelf or in the vicinity of the latter and the quantity of light received by the photoresistor varying according to the presence of at least one article on the shelf.

15. The device as claimed in claim 2, wherein the RFID tag is connected to a plurality of detector circuits mounted in series.

16. The device as claimed in claim 3, wherein the RFID tag is connected to a plurality of detector circuits mounted in series.

17. The device as claimed in claim 4, wherein the RFID tag is connected to a plurality of detector circuits mounted in series.

18. The device as claimed in claim 5, wherein the RFID tag is connected to a plurality of detector circuits mounted in series.

19. The device as claimed in claim 6, wherein the RFID tag is connected to a plurality of detector circuits mounted in series.

20. The device as claimed in claim 7, wherein the RFID tag is connected to a plurality of detector circuits mounted in series.
